(19) United States
(12) Patent Application Publication
(10) Pub. No.: US 2017/0035233 A1
(43) Pub. Date: Feb. 9, 2017

(54) Cucumber core remover

(71) Applicant: Chikara R. Tateno, Santa Cruz, CA (US)

(72) Inventor: Chikara R. Tateno, Santa Cruz, CA (US)

(21) Appl. No.: 14/756,149

(22) Filed: Aug. 7, 2015

(51) Int. Cl. A47J 25/00

(52) U.S. Cl. CPC A47J 25/00

(57) ABSTRACT

A device for removing the core of a cucumber, comprising a handle, a coring blade support and a positioning element or shank being operably secured to the handle, and a coring blade. The coring blade support and positioning element may extend a length beyond the coring blade allowing for control of the penetration and depth of cut of the coring blade. The coring blade may be configured as a half-ring with a sharpened edge or otherwise, and the coring blade support and positioning element may be rounded or flat.

### BACKGROUND OF THE INVENTION

Technical Field

This invention relates to devices for cucumber core removal, and more particularly to a hand held cucumber core remover for cucumber core extraction.

Background Art

Cucumber (Cucumis sativus) is a widely grown plant in the family Cucurbitaceae. It is a vine plant that bears cylindrical fruits that are used as culinary vegetables. There are three main varieties of cucumbers, slicing, pickling and burpless. Originally from South Asia, it is now grown on most continents and is a popular food in many types of cooking.

The fruit of the cucumber is generally cylindrical, being elongated with tapered ends, and may grow to be over two feet in length and 4 inches in diameter. Since cucumbers have an enclosed seed and develop from a flower, botanically cumbers are classified as an accessory fruit. Similar to tomatoes and squash, cucumbers are often perceived, prepared and eaten as vegetables. Cucumbers have a long an colorful history being used in many folk medicinal applications as well as many culinary preparations.

Various devices have been proposed and implemented for coring fruits and vegetables and other food products. Although prior devices have been adapted and used for various purposes in connection with coring, fruits and vegetables and other food products, applicant is not aware of any device specifically constructed and configured for coring cucumbers.

The present invention provides a device for coring cucumbers, which is easy to use and operate, and is highly efficient. The device of the present invention has a handle, and an elongated blade positioning element, and either one or two curved cutting blades operably positioned thereon to core a cucumber.

Accordingly, the primary object of the present invention is to provide a cucumber coring device, which is easy to use, highly efficient, and reduces cucumber preparation time greatly. The cucumber coring device of the present invention is particularly useful in food preparation, such as making sushi and the like.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### SUMMARY OF INVENTION

To achieve the foregoing objects, and in accordance with the purpose of the invention as embodied and broadly described herein, a device for removing the core of a cucumber, comprising a handle, a shank or coring blade support and positioning element is operably secured to the handle and to a coring blade. The coring blade support and positioning element or shank extends a length beyond the coring blade allowing for control of the penetration and depth of cut of the coring blade. The coring blade may be configured as a half-ring with a sharpened edge, a half-circle shape, or otherwise, and the coring blade support and positioning element may be rounded or flat.

### BRIEF DESCRIPTION OF DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 shows the cucumber core remover for removing the core of a cucumber, having a rounded shank or coring support and positioning element, according to the invention.

FIG. 2 shows the cucumber core remover for removing the core of a cucumber, in this embodiment with two coring blades, according to the invention.

FIG. 3 shows the cucumber core remover for removing the core of a cucumber, having a flat shank or coring support and positioning element, according to the invention.

FIG. 4 shows the cucumber core remover for removing the core of a cucumber, in this embodiment with two coring blades, having a flat shank or coring support and positioning element, according to the invention.

FIG. 5 shows a longitudinal section view of a cut cucumber with the cucumber removing device of the invention operably removing the core therefrom, according to the invention.

### DETAILED DESCRIPTION OF THE PREFERRED EMBODIMENT

Reference will now be made in detail to the present preferred embodiments of the invention as illustrated in the accompanying drawings.

In accordance with the present invention, as seen in FIG. 1, there is provided in a preferred embodiment of the invention, a cucumber core remover 10, for removing the core of a cucumber, comprising, a handle 12, a shank element 14, operably secured to the handle 10, and a core remover blade 16, for removing the core of the cucumber. The core remover blade 16, is preferably configured as a half-ring, as seen in FIG. 1, but may be otherwise, such as a semi-circle, cup-shaped, or the like, and preferably has a sharpened edge 17.

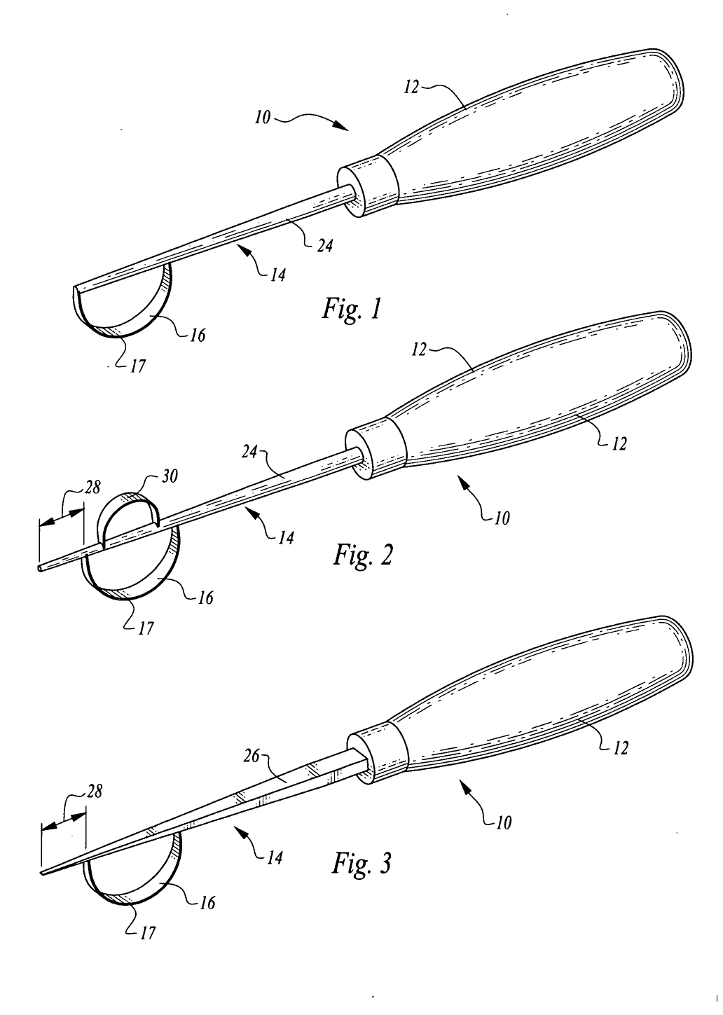

As seen in FIG. 2, core remover blade 16, may be positioned on shank element 14, so that the shank 14, extends a predetermined length 28, which may be from about ⅛ inch to about 3 inches beyond the core remover blade 16, or other chosen length, allowing for control of the penetration and depth of cut of the core removal blade.

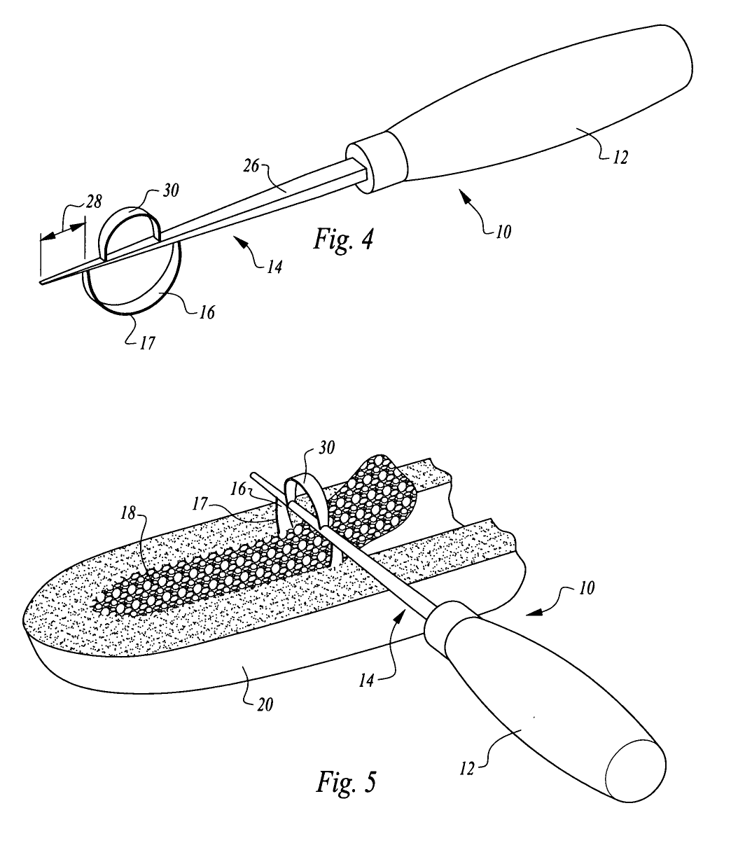

As seen in FIG. 1, shank 14, may be configured rounded 24, or alternatively flat 26, as seen in FIGS. 3 and 4. Of course any elongated configuration of shank 14, may be utilized, however the rounded 24 and flat 26, configurations are preferred.

The cucumber core remover 10, may also be constructed having a second core remover blade 30, as seen in FIG. 2 and FIG. 4 secured to the shank 14. Core remover blade 16, and second core remover blade 30, may be secured to shank 14, by any of a number of well know means such as adhesives, welds, rings, fasteners, or formed integrally therewith as in the case where cucumber core remover 10, is made of plastic or other durable resilient moldable material. If core remover 10, is constructed using a mold for plastics or thermoplastics and the like, it is possible to make cucumber core remover 10, as a single piece unit with handle 12, shank 14, and core remover blade 16, formed as a single integral device.

With reference now to FIG. 2, shows the cucumber core remover 10, for removing the core of a cucumber, in this embodiment with two coring blades 16 and 30, according to the invention. Shank 14, is shown rounded 24, in this view and extends predetermined length 28, which may be from about ¼ to about 3 inches, here shown about 1 inch, beyond the core remover blade 16 and blade 30, allowing for control of the penetration and depth of cut of the core removal blade.

In FIG. 3 the cucumber core remover 10, for removing the core of a cucumber, is shown having having a flat 26, shank 14, or coring support and positioning element, according to the invention. In FIG. 3, an embodiment with one core removal or coring blade 16, with a sharpened edge 17, is shown.

FIG. 4 shows the cucumber core remover 10, for removing the core of a cucumber, in this embodiment with two coring blades 16, and 30, having a flat 26, shank or coring support and positioning element 14, and predetermined length 28, extension of shank or or coring positioning and support element 14.

With reference now to FIG. 5, a preferred method of use of cucumber core remover 10, is shown in a preferred operational mode. In FIG. 5, a longitudinal section view of a cut cucumber 20, with core 18, is shown with the cucumber remover 10, operably removing the core therefrom, according to the invention. Cucumber core remover 10, is best used on a longitudinally cut cucumber as seen in FIG. 5, and core removing blade 16, positioned over cucumber core 18, insertd into the cucumber, and either pulled or pushed the length of the cucumber and core 18, is removed intact, allowing for use in sushi and other culinary preparations.

In operation and use, cucumber core remover 10, is easy, efficient, and fun to use. Core remover 10, is particularly suited for culinary preparations such as sushi and allows for cucumber cores to be rapidly removed intact from a cucumber. In a preferred application, as seen in FIG. 5, a cucumber is first cut in half longitudinally, and the cucumber core remover 10, aligning core remover blade 16, with cucumber core 18, and then the cucumber core remover either pushed or pulled the length of the cucumber. Cucumber core remover 10, may be provided in a wide variety of different sizes and configurations, and made out of a wide variety of materials, such as plastic, metal, wood, or any other durable resilient material.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A cucumber core remover, comprising:
a handle;
a shank element secured to said handle;
a core remover blade for removing the core of said cucumber, said core remover blade being configured as a half-ring and is positioned on said shank element.

2. The cucumber core remover of claim 1, wherein said shank is rounded.

3. The cucumber core remover, of claim 1, wherein said shank is flat.

4. The cucumber core remover of claim 1, wherein said shank extends beyond the core remover blade allowing for control of the penetration and depth of cut of the core removal blade.

5. The cucumber core remover of claim 1, further including a second core remover blade secured to the shank.

6. The cumber core remover of claim 1, wherein said second core remover blade is configured as a half-ring.

7. A cucumber coring device, comprising:
a handle;
a shank secured to said handle;
a coring blade for removing the core of said cucumber, said core remover blade being positioned on said shank so that said shank extends a length beyond the coring blade, allowing for control of the penetration and depth of a core cut.

8. The cucumber coring device of claim 7, wherein said coring blade is configured as a half-ring and is positioned on said shank element.

9. The cucumber coring device of claim 7, wherein said coring blade is configured as a half-circle.

10. The cucumber coring device of claim 7, wherein said coring blade has a sharpened edge.

11. The cucumber coring device of claim 7, wherein said shank is rounded.

12. The cucumber coring device of claim 7, wherein said shank is flat.

13. The cucumber coring device of claim 7, further including a second core remover blade secured to the shank.

14. The cucumber coring device of claim 7, wherein said second core remover blade is configured as a half-ring.

15. A device for removing the core of a cucumber, comprising:
a handle;
a coring blade support and positioning element, said coring blade support and positioning element being operably secured to a coring blade; and said coring blade support and positioning element extending a length beyond the coring blade allowing for control of the penetration and depth of cut of the coring blade.

16. The device of claim 15, wherein said coring blade is configured as a half-ring.

17. The cucumber coring device of claim 15, wherein said coring blade has a sharpened edge.

18. The cucumber coring device of claim 15, wherein said coring blade support and positioning element is rounded.

19. The cucumber coring device of claim 15, wherein said coring blade support and positioning element is flat.
